(19) United States
(12) Patent Application Publication
(10) Pub. No.: US 2012/0072881 A1
(43) Pub. Date: Mar. 22, 2012

(54) DESIGN APPARATUS, METHOD FOR HAVING COMPUTER DESIGN SEMICONDUCTOR INTEGRATED CIRCUIT, AND NON-TRANSITORY COMPUTER-READABLE MEDIUM

(75) Inventor: Norifumi Kobayashi, Yokohama-Shi (JP)

(73) Assignee: Kabushiki Kaisha Toshiba, Tokyo (JP)

(21) Appl. No.: 13/052,581

(22) Filed: Mar. 21, 2011

(30) Foreign Application Priority Data
Sep. 17, 2010 (JP) 2010-209881

(51) Int. Cl. G06F 17/50

(52) U.S. Cl. 716/130

(57) ABSTRACT

According to one embodiment, a design apparatus includes an extractor, a regression equation generator and an output module. The extractor extracts a critical part from a net list of a semiconductor integrated circuit. The critical part has a delay value greater than a delay threshold. The regression equation generator generates a regression equation to reproduce the delay value of the critical part using a regression algorithm. The output module outputs the regression equation.

### CROSS REFERENCE TO RELATED APPLICATIONS

This application is based upon and claims the benefit of priority from the prior Japanese Patent Application No. 2010-209881, filed on Sep. 17, 2010, the entire contents of which are incorporated herein by reference.

### FIELD

Embodiments described herein relate generally to a design apparatus, a method for having a computer design a semiconductor integrated circuit, and a non-transitory computer-readable medium.

### BACKGROUND

A general LSI (Large Scale Integration) is completed through a design stage, a manufacture stage, and an evaluation stage. At the design stage, the LSI is designed. At the manufacture stage, the LSI is manufactured based on the design made at the design stage. Performance (for example, operation speed) of the LSI manufactured at the manufacture stage is evaluated at the evaluation stage.

Conventionally, a method for incorporating a ring oscillator into the LSI to utilize an oscillation frequency of the ring oscillator or a delay value of a delay chain is well known as a method for evaluating the LSI performance.

However, in the conventional method, the LSI performance is not evaluated prior to the evaluation stage (i.e. during the design and production stages). That is, the LSI is not designed at the design stage in consideration of the LSI performance. As a result, in order to guarantee the LSI performance, it is necessary to make a design at the design stage such that the LSI performance has a sufficient margin, which adversely affects productivity of the LSI at the manufacture stage. For example, in the conventional method, it is necessary to design the LSI in which the ring oscillator is incorporated at the design stage in order to enable the LSI performance to have the sufficient margin. Therefore, a circuit size of the LSI is excessively enlarged.

In other words, specifications of the general LSI are defined in consideration of a predetermined margin at the design stage (hereinafter referred to as “design budget”), the manufacture stage, and the evaluation stage. However, in the conventional method, a large portion of the design budget is consumed at the design stage. Therefore, the design budget insufficiently remains at the manufacture stage.

### BRIEF DESCRIPTION OF THE DRAWINGS

FIG. 1 is a block diagram illustrating a configuration of a design apparatus 1 of an embodiment.

FIG. 2 is a flowchart illustrating a procedure of the design operation of the first embodiment.

FIG. 3 is a flowchart illustrating a procedure of the design operation of the second embodiment.

FIG. 4 is a flowchart illustrating a procedure of the design operation of the third embodiment.

### DETAILED DESCRIPTION

Embodiments will now be explained with reference to the accompanying drawings.

In general, according to one embodiment, a design apparatus includes an extractor, a regression equation generator and an output module. The extractor extracts a critical part from a net list of a semiconductor integrated circuit. The critical part has a delay value greater than a delay threshold. The regression equation generator generates a regression equation to reproduce the delay value of the critical part using a regression algorithm. The output module outputs the regression equation.

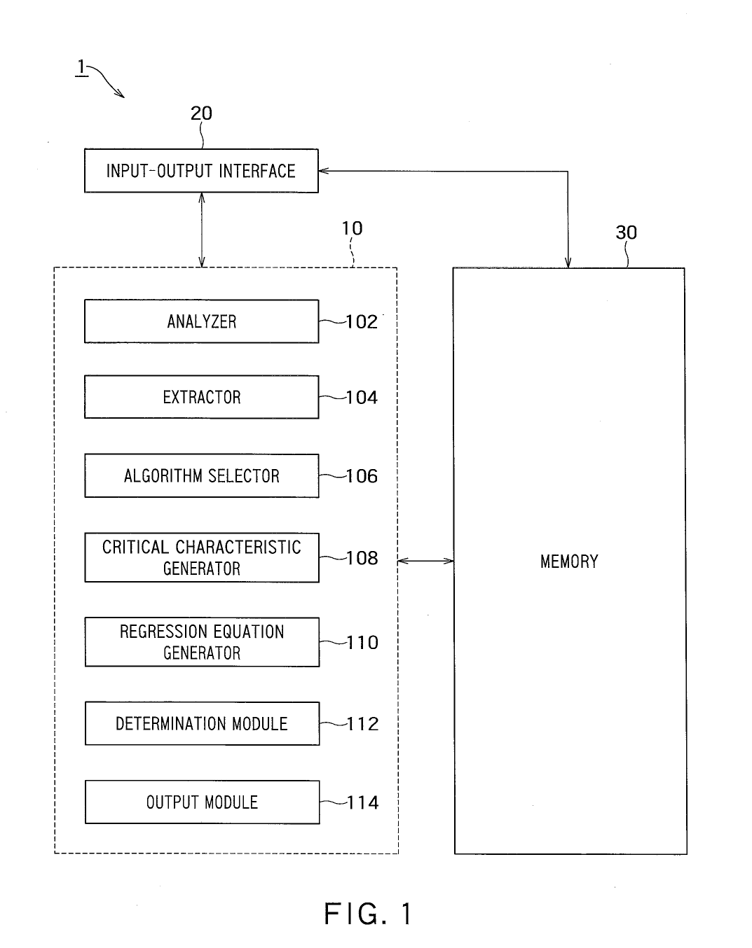

Hereafter, a design apparatus of the embodiment will be explained more specifically. FIG. 1 is a block diagram illustrating a configuration of a design apparatus 1 of an embodiment.

The design apparatus 1 of FIG. 1 is used in the design stage and outputs a regression equation to reproduce a delay of the LSI based on a net list of a circuit configuration of the LSI. The design apparatus 1 includes a processor 10, an input-output interface 20, and a memory 30. The net list means data of connection information indicating a connection relationship of a transistor, a capacitance value and connection information of a capacitor, and a resistance value and connection information of a resistor.

The processor 10 is a module which executes a design program stored in the memory 30, thereby implementing a design application for performing a design operation of the embodiment. The processor 10 implements an analyzer 102, an extractor 104, an algorithm selector 106, a critical characteristic generator 108, a regression equation generator 110, a determination module 112, and an output module 114.

The input-output interface 20 is an interface which inputs information necessary for the design operation and outputs a result of the design operation. The input-output interface 20 is connected to an input device such as a keyboard, an output device such as a display, the processor 10, and the memory 30. A user using the design apparatus 1 feeds the information necessary for the design operation to the processor 10 through the input-output interface 20 and obtains the result of the design operation. The input-output interface 20 may be connected to the input device and the output device through a network.

The information necessary for the design operation and the design program are stored in the memory 30. The result of the design operation can also be stored in the memory 30. For example, the memory 30 is a hard disk or a computer-readable medium such as a flash memory.

### First Embodiment

A first embodiment will be explained below. In the first embodiment, by way of example, the regression equation is generated to reproduce a delay of a critical path.

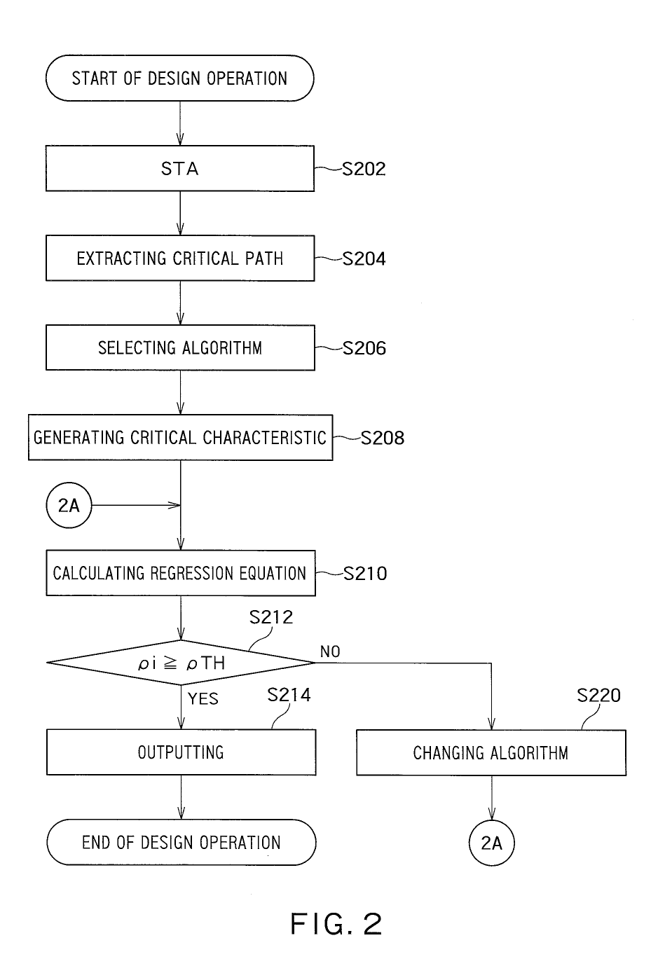

A design operation of the first embodiment will now be explained. FIG. 2 is a flowchart illustrating a procedure of the design operation of the first embodiment.

<STA (S202)> The analyzer 102 performs a STA (Static Timing Analysis) to the LSI net list fed through the input-output interface 20 using a predetermined timing model. The timing model is previously incorporated into the design application. Therefore, a path table (see TABLE 1) including a delay value Di of a path Pi (i denotes a natural number) between two nodes of the LSI is generated. TABLE 1 illustrates the path table including delay values D1 to D4 of paths P1 to P4.

TABLE 1
PATH TABLE

| | DELAY |
|---|---|
| PATH (Pi) | VALUE (DI) |
| P1 | D1 |
| P2 | D2 |
| P3 | D3 |
| P4 | D4 |

<EXTRACTING CRITICAL PATH (S204)> The extractor 104 extracts a critical path CPi having a delay value Di which is greater than a predetermined delay threshold DTH from the path Pi having the delay value Di obtained in the STA (S202). That is, the critical path CPi constitutes a rate-controlling factor of the LSI. The delay threshold DTH is information fed by the user through the input-output interface 20. Therefore, a critical path table (see TABLE 2) illustrating the delay value Di of the critical path CPi is generated. In TABLE 2, the critical path CP1 corresponds to the path P1 and the critical path CP3 corresponds to the path P3. That is, the delay values D1 and D3 are greater than the delay threshold DTH.

TABLE 2
CRITICAL PATH TABLE

| CRITICAL | DELAY |
|---|---|
| PATH | VALUE |
| (CPi) | (Di) |
| CP1 | D1 |
| CP2 | D3 |

<SELECTING ALGORITHM (S206)> The algorithm selector 106 selects an arbitrary regression algorithm Am (m denotes a natural number) from plural regression algorithms. The plural regression algorithms are previously incorporated into the design application. The regression algorithm may be either a single regression algorithm or a multiple regression algorithm.

<GENERATING CRITICAL CHARACTERISTIC (S208)> The critical characteristic generator 108 calculates a critical characteristic CSi of all the critical paths extracted in extracting critical path (S204), by applying a predetermined process condition to the regression algorithm Am selected in selecting algorithm (S206). The process condition is a parameter fed by the user through the input-output interface 20, which is determined in consideration of a manufacture variation and a recipe condition used in the manufacture stage (for example, a dose amount of ion implantation, a temperature condition at the manufacture stage, an process time at the manufacture stage, and an process interval at the manufacture stage). The parameter is determined so that a characteristic of a transistor constituting the LSI, a parasitic resistance and a parasitic capacitance of wiring, and a parasitic resistance and a parasitic capacitance of a capacitor fall within predetermined ranges. The critical characteristic CSi includes a process sensitivity (PROCESS SENS.) CSPi, a source voltage sensitivity (SOURCE VOLTAGE SENS.) CSVi and a temperature sensitivity (TEMP. SENS.) CSTi. The process sensitivity CSPi is a process dependence which indicates a degree of dependence of the delay value Di of the critical path CPi on the process in the manufacture stage. The source voltage sensitivity CSVi is a source voltage dependence which indicates a degree of dependence of the delay value Di of the critical path CPi on a source voltage of the LSI. The temperature sensitivity CSTi is a temperature dependence which indicates a degree of dependence of the delay value Di of the critical path CPi on an operation temperature of the LSI. Therefore, a critical characteristic table (see TABLE 3) illustrating the critical characteristic CSi of the critical path CPi is generated.

TABLE 3
CRITICAL CHARACTERISTIC TABLE

| | CRITICAL CHARACTERISTIC | | |
|---|---|---|---|
| | (CSi) | | |
| | | SOURCE | |
| CRITICAL | PROCESS | VOLTAGE | TEMP. |
| PATH | SENS. | SENS. | SENS. |
| (CPi) | (CSPi) | (CSVi) | (CSTi) |
| CP1 | CSP1 | CSV1 | CST1 |
| CP3 | CSP3 | CSV3 | CST3 |

<CALCULATING REGRESSION EQUATION (S210)> The regression equation generator 110 generates a regression equation Fi to reproduce the delay value of the critical path CPi using a reproduction characteristic RSj including a process sensitivity (PROCESS SENS.) RSPj, a source voltage sensitivity (SOURCE VOLTAGE SENS.) RSVj and a temperature sensitivity (TEMP. SENS.) RSTj, which is reproduced by a delay reproduction module such as a ring oscillator (RING OSC.) ROj of a predetermined process table (see TABLE 4), and a contribution ratio of the regression algorithm Am selected in selecting algorithm (S206). Specifically, the regression equation generator 110 generates the regression equation Fi, which expresses the delay value most approximate to the delay value Di of the critical path CPi, while changing the contribution ratio of the regression algorithm Am in consideration of a delay value RDj of the process table. Any number of regression equations Fi may be generated as long as the number of critical paths CPi is greater than the number of regression equations Fi.

TABLE 4
PROCESS TABLE

| | REPRODUCTION | | | |
|---|---|---|---|---|
| | CHARACTERISTIC (RSj) | | | |
| | | SOURCE | | |
| RING | PROCESS | VOLTAGE | TEMP. | DELAY |
| OSC. | SENS. | SENS. | SENS. | VALUE |
| (ROj) | (RSPi) | (RSVi) | (RSTi) | (RDj) |
| RO1 | RSP1 | RSV1 | RST1 | RD1 |
| RO2 | RSP2 | RSV2 | RST2 | RD2 |

The process table may be fed by the user through the input-output interface 20 or generated by the regression equation generator 110 based on a library of the timing model used in the STA (S202). The process table shows the reproduction characteristic RSj including a process sensitivity (PROCESS SENS.) RSPj, a source voltage sensitivity (SOURCE VOLTAGE SENS.) RSVj and a temperature sensitivity (TEMP. SENS.) RSTj, and a delay value RDj, which correspond to the ring oscillator (RING OSC.) ROI. The process table of TABLE 4 shows reproduction properties RS1 and RS2, and delay values RD1 and RD2, which correspond to the ring oscillators RO1 and RO2. The reproduction properties RS1 and RS2 respectively include the process sensitivities RSP1 and RSP2, the source voltage sensitivities RSV1 and RSV2, and the temperature sensitivities RST1 and RST2.

<S212> The determination module 112 calculates a correlation coefficient ρi of the regression equation Fi generated in calculating regression equation (S210) based on a difference between the reproduction characteristic RSj of the ring oscillator included in the regression equation Fi and the critical characteristic CSi of the critical path CPi. Subsequently, the determination module 112 determines whether the correlation coefficient ρi is equal to or greater than a predetermined correlation threshold ρTH. The correlation threshold ρTH is information fed by the user through the input-output interface 20. When the correlation coefficient ρi is equal to or greater than the correlation threshold ρTH (S212-YES), outputting (S214) is performed. When the correlation coefficient ρi is lower than the correlation threshold ρTH (S212-NO), changing algorithm (S220) is performed.

<OUTPUTTING (S214)> The output module 114 outputs the design operation result through the input-output interface 20. The design operation result is the regression equation Fi which has the correlation coefficient ρi equal to or greater than the correlation threshold ρTH. Therefore, the user can easily obtain such regression equation Fi having the correlation coefficient ρi equal to or greater than the correlation threshold ρTH as the optimum information necessary to reproduce the delay of the LSI at the design stage. When outputting (S214) is ended, the design operation is ended. The design operation result (that is, such regression equation Fi) may be stored in the memory 30.

<CHANGING ALGORITHM (S220)> The algorithm selector 106 adds 1 to the value of “m” that is the identification information on the regression algorithm. Therefore, a regression algorithm Am+1, which is different from the regression algorithm Am used in GENERATING CRITICAL CHARACTERISTIC (S208) and calculating regression equation (S210) before changing algorithm (S220), is used in GENERATING CRITICAL CHARACTERISTIC (S208) and calculating regression equation (S210) after changing algorithm (S220). That is, the algorithm selector 106 changes the regression algorithm used in GENERATING CRITICAL CHARACTERISTIC (S208) and calculating regression equation (S210) until the correlation coefficient ρi equal to or greater than the correlation threshold ρTH is obtained. When changing algorithm (S220) is ended, calculating regression equation (S210) is performed.

In the manufacture stage subsequent to the design operation of the first embodiment, the ring oscillator ROj of the process table (see TABLE 4) is incorporated into the LSI based on the design operation result (that is, such regression equation Fi) outputted in outputting (S214) of FIG. 2. Then, the user evaluates the LSI performance using the ring oscillator ROj incorporated into the LSI at the evaluation stage subsequent to the manufacture stage. The design operation result (that is, such regression equation Fi) expresses the minimum ring oscillator ROj necessary to reproduce the delay value Di of the critical path CPi. Accordingly, the user can evaluate the LSI performance without excessively enlarging the circuit size of the LSI.

### Second Embodiment

A second embodiment will be explained below. In the second embodiment, by way of example, a regression equation is generated to reproduce a delay of a critical net including plural critical paths. In the second embodiment, the description of the constituent similar to that of the first embodiment is not repeated.

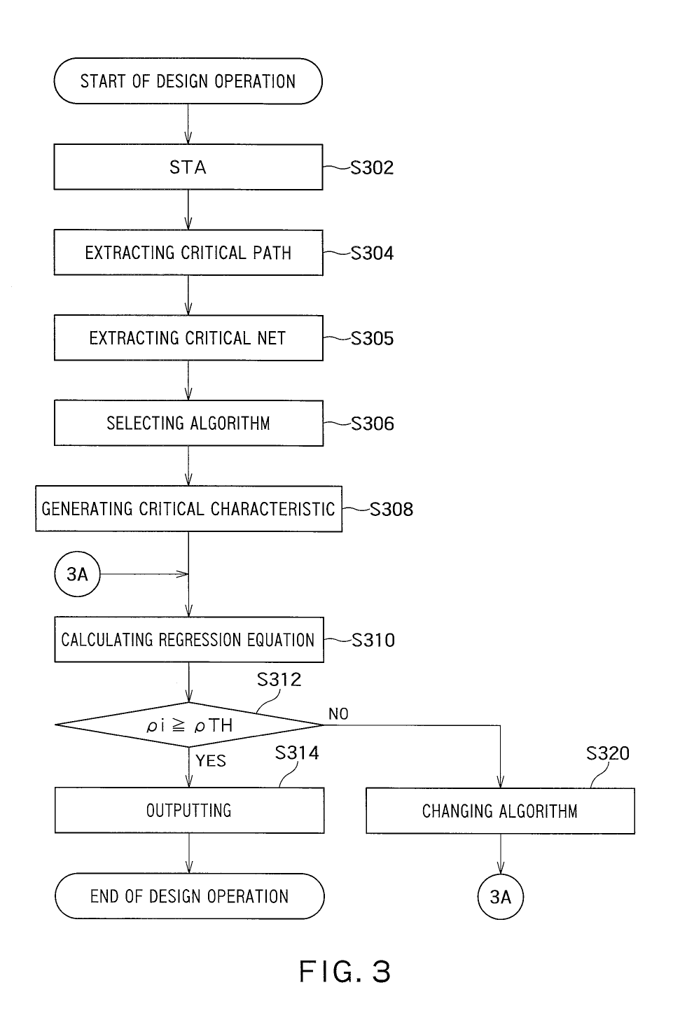

A design operation of the second embodiment will now be explained. FIG. 3 is a flowchart illustrating a procedure of the design operation of the second embodiment.

<STA (S302) to EXTRACTING CRITICAL PATH (S304)> The STA (S302) to extracting critical path (S304) are similar to those of the first embodiment (STA (S202) and extracting critical path (S204) of FIG. 2).

<EXTRACTING CRITICAL NET (S305)> The extractor 104 extracts a route (hereinafter referred to as “critical net CNi”) including the plural critical paths CPi obtained in extracting critical path (S304). The critical net CNi is a route that constitutes a rate-controlling factor of the LSI, which includes plural paths including at least one critical path CPi. Then the extractor 104 calculates a delay value DNi of the critical net CNi using the path table (see TABLE 1) generated in the STA (S302). Therefore, a critical net table (see TABLE 5) is generated. The critical net table shows the path Pi included in and the delay value DNi in each critical net CNi. TABLE 5 shows a delay value DN1 of a critical net CN1 including a critical path CP1 and the path P2, and a delay value DN3 of a critical net CN3 including a critical path CP3 and the path P4.

TABLE 5
CRITICAL NET TABLE

| CRITICAL | PATH | DELAY |
|---|---|---|
| NET | IN CRITICAL NET | VALUE |
| (CNi) | (Pi) | (DNi) |
| CN1 | P1(CP1), P2 | DN1 |
| CN3 | P3(CP3), P4 | DN3 |

<SELECTING ALGORITHM (S306)> Selecting algorithm (S306) is similar to that of the first embodiment (selecting algorithm (S206) of FIG. 2).

<GENERATING CRITICAL CHARACTERISTIC (S308)> The critical characteristic generator 108 calculates a critical characteristic CSi of all the critical nets extracted in extracting critical net (S305), by applying a predetermined process condition to the regression algorithm Am selected in selecting algorithm (S306). The process condition is a parameter fed by the user through the input-output interface 20, which is used at the manufacture stage. The critical characteristic CSi includes a process sensitivity CSPi, a source voltage sensitivity CSVi, and a temperature sensitivity CSTi. The process sensitivity CSPi is a process dependence of the delay value DNi of the critical net CNi. The source voltage sensitivity CSVi is a source voltage dependence of the delay value DNi of the critical net CNi. The temperature sensitivity CSTi is a temperature dependence of the delay value DNi of the critical net CNi. Therefore, a critical characteristic table (see TABLE 6) showing the critical characteristic CSi of the critical net CNi is generated.

TABLE 6
CRITICAL CHARACTERISTIC TABLE

| | CRITICAL CHARACTERISTIC | | |
|---|---|---|---|
| | (CSi) | | |
| | | SOURCE | |
| CRITICAL | PROCESS | VOLTAGE | TEMP. |
| NET | SENS. | SENS. | SENS. |
| (CNi) | (CSPi) | (CSVi) | (CSTi) |
| CN1 | CSP1 | CSV1 | CST1 |
| CN3 | CSP3 | CSV3 | CST3 |

<CALCULATING REGRESSION EQUATION (S310)> The regression equation generator 110 generates a regression equation Fi to reproduce the delay value DNi of the critical net CNi using the reproduction characteristic RSj including a process sensitivity RSPj, a source voltage sensitivity RSVj and a temperature sensitivity RSTj, which corresponds to the delay reproduction module such as the ring oscillator ROj of the process table (see TABLE 4), and a contribution ratio of the regression algorithm Am selected in selecting algorithm (S306). Specifically, the regression equation generator 110 generates the regression equation Fi, which expresses the delay value most approximate to the delay value DNi of the critical net CNi, while changing the contribution ratio of the regression algorithm Am in consideration of the delay value RDj of the process table. Any number of regression equations Fi may be generated as long as the number of critical net CNi is greater than the number of regression equations Fi.

<S312> The determination module 112 calculates the correlation coefficient ρi of the regression equation Fi generated in calculating regression equation (S310) based on a difference between the reproduction characteristic RSj of the ring oscillator included in the regression equation Fi and the critical characteristic CSi of the critical net CNi. Subsequently, the determination module 112 determines whether the correlation coefficient ρi is equal to or greater than a predetermined correlation threshold ρTH. The correlation threshold ρTH is information fed by the user through the input-output interface 20. When the correlation coefficient ρi is equal to or greater than the correlation threshold ρTH (S312-YES), outputting (S314) is performed. When the correlation coefficient ρi is lower than the correlation threshold ρTH (S312-NO), changing algorithm (S320) is performed.

<OUTPUTTING (S314) and CHANGING ALGORITHM (S320)> Outputting (S314) and changing algorithm (S320) are similar to those of the first embodiment (outputting (S214) and changing algorithm (S220) of FIG. 2).

In the manufacture stage subsequent to the design operation of the second embodiment, the ring oscillator ROj of the process table (see TABLE 4) is incorporated into the LSI based on the design operation result (that is, such regression equation Fi having the correlation coefficient ρi equal to or greater than the correlation threshold ρTH) outputted in outputting (S314) of FIG. 3. Then, the user evaluates the LSI performance using the ring oscillator ROj incorporated into the LSI at the evaluation stage subsequent to the manufacture stage. The design operation result (that is, such regression equation Fi) expresses the minimum ring oscillator ROj necessary to reproduce the delay value DNi of the critical net CNi. Accordingly, the user can evaluate the LSI performance without excessively enlarging the circuit size of the LSI.

### Third Embodiment

A third embodiment will be explained below. In the third embodiment, by way of example, a regression equation is generated in consideration of the process sensitivity in each of an NMOS (Negative Metal Oxide Semiconductor) transistor and a PMOS (Positive Metal Oxide Semiconductor) transistor. In the third embodiment, the description of the constituent similar to that of the first and second embodiments is not repeated.

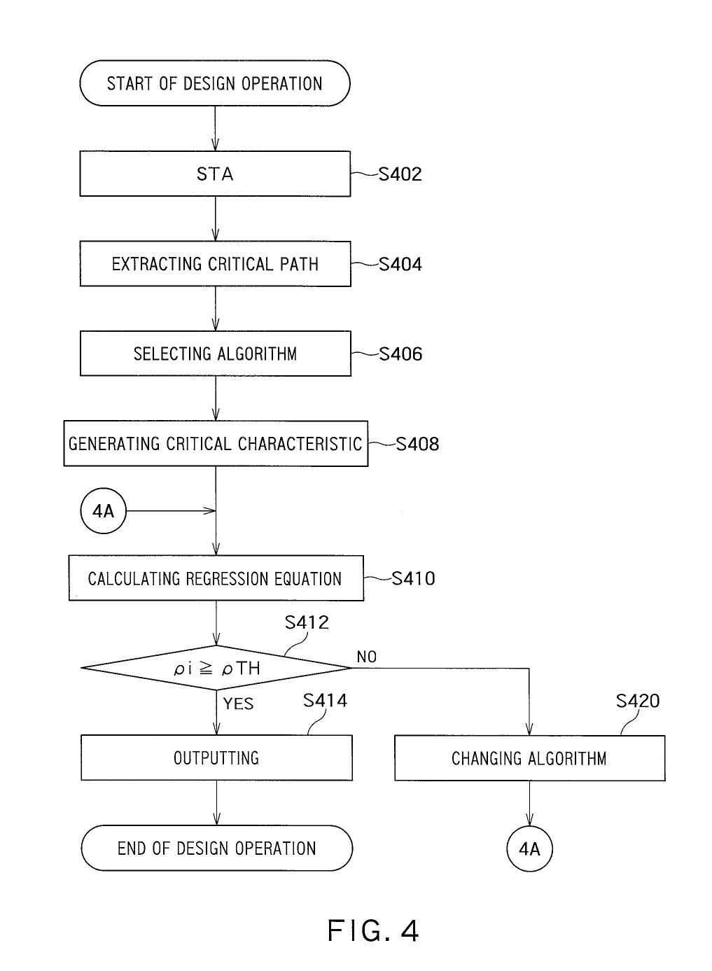

A design operation of the third embodiment will now be explained. FIG. 4 is a flowchart illustrating a procedure of the design operation of the third embodiment.

<STA (S402) to SELECTING ALGORITHM (S406)> The STA (S402) to selecting algorithm (S406) are similar to those of the first embodiment (STA (S202) to selecting algorithm (S266) of FIG. 2).

<GENERATING CRITICAL CHARACTERISTIC (S408)> The critical characteristic generator 108 calculates all the critical characteristic CSi extracted in extracting critical path (S404), by applying a predetermined process condition to the regression algorithm Am selected in selecting algorithm (S406). The process condition is a parameter fed by the user through the input-output interface 20, which is used at the manufacture stage of the LSI. The critical characteristic CSi includes a first process sensitivity (FIRST PROCESS SENS.) CSNPi, a second process sensitivity (SECOND PROCESS SENS.) CSPPi, a source voltage sensitivity (SOURCE VOLTAGE SENS.) CSVi, and a temperature sensitivity (TEMP. SENS.) CSTi. The first process sensitivity CSNPi is a process dependence of the delay value DNi of the critical path CPi when the NMOS transistor is used. The second process sensitivity CSPPi is a process dependence of the delay value DNi of the critical path CPi when the PMOS transistor is used. The source voltage sensitivity CSVi is a source voltage dependence of the delay value DNi of the critical path CPi. The temperature sensitivity CSTi is a temperature dependence of the delay value DNi of the critical path CPi. Therefore, a critical characteristic table (see TABLE 7) showing the critical characteristic CSi of the critical path CPi is generated.

TABLE 7
CRITICAL CHARACTERISTIC TABLE

| | CRITICAL CHARACTERISTIC | | | |
|---|---|---|---|---|
| | FIRST | SECOND | SOURCE | |
| CRITICAL | PROCESS | PROCESS | VOLTAGE | TEMP. |
| PATH | SENS. | SENS. | SENS. | SENS. |
| (CPi) | (CSNPi) | (CSPPi) | (CSVi) | (CSTi) |
| CP1 | CSNP1 | CSPP1 | CSV1 | CST1 |
| CP3 | CSNP3 | CSPP3 | CSV3 | CST3 |

<CALCULATING TWO-DIMENSIONAL REGRESSION EQUATION (S410)> The regression equation generator 110 generates a two-dimensional regression equation Fi to reproduce the delay value Di of the critical path CPi using the reproduction characteristic RSj including a first process sensitivity RSNPj, a second process sensitivity RSPPj, a source voltage sensitivity RSVj and a temperature sensitivity RSTj, which corresponds to the delay reproduction module such as the ring oscillator ROj of a process table (see TABLE 8), and a contribution ratio of the regression algorithm Am selected in selecting algorithm (S406). Specifically, the regression equation generator 110 generates the two-dimensional regression equation Fi, which expresses the delay value most approximate to the delay value DNi of the critical path CPi, while changing the contribution ratio of the regression algorithm Am in consideration of the delay value RDj of the process table of TABLE 8. That is, the regression equation generator 110 generates the two-dimensional regression equation Fi in consideration of the process sensitivity including the first process sensitivity RSNPj and the second process sensitivity RSPPj. Any number of two-dimensional regression equations Fi may be generated as long as the number of critical path CPi is greater than the number of two-dimensional regression equations Fi.

TABLE 8
PROCESS TABLE

| | REPRODUCTION CHARACTERISTIC (RSj) | | | | |
|---|---|---|---|---|---|
| | 1ST | 2ND | SOURCE | | |
| RING | PROCESS | PROCESS | VOLTAGE | TEMP. | DELAY |
| OSC. | SENS. | SENS. | SENS. | SENS. | VALUE |
| (ROj) | (RSNPj) | (RSPPj) | (RSVj) | (RSTj) | (RDj) |
| RO1 | RSNP1 | RSPP1 | RSV1 | RST1 | RD1 |
| RO2 | RSNP2 | RSPP2 | RSV2 | RST2 | RD2 |

<S412> The determination module 112 calculates the correlation coefficient ρi of the two-dimensional regression equation Fi generated in calculating two-dimensional regression equation (S410) based on a difference between the reproduction characteristic RSj of the ring oscillator included in the regression equation Fi and the critical characteristic CSi of the critical path CPi. Subsequently, the determination module 112 determines whether the correlation coefficient ρi is equal to or greater than a predetermined correlation threshold ρTH. The correlation threshold ρTH is information fed by the user through the input-output interface 20. When the correlation coefficient ρi is equal to or greater than the correlation threshold ρTH (S412-YES), outputting (S414) is performed. When the correlation coefficient ρi is lower than the correlation threshold ρTH (S412-NO), changing algorithm (S420) is performed.

<OUTPUTTING (S414)> The output module 114 outputs the design operation result through the input-output interface 20. The design operation result is the two-dimensional regression equation Fi which has the correlation coefficient ρi equal to or greater than the correlation threshold ρTH. Therefore, the user can easily obtain such two-dimensional regression equation Fi having the correlation coefficient ρi equal to or greater than the correlation threshold ρTH as the optimum information necessary to reproduce the delay of the LSI at the design stage. When outputting (S414) is ended, the design operation is ended. The design operation result (that is, such two-dimensional regression equation Fi) may be stored in the memory 30.

<CHANGING ALGORITHM (S420)> Changing algorithm (S420) is similar to that of the first embodiment (changing algorithm (S220) of FIG. 2).

In the manufacture stage subsequent to the design operation of the third embodiment, the ring oscillator ROj of the process table (see TABLE 8) is incorporated into the LSI based on the design operation result (that is, such two-dimensional regression equation Fi) outputted in outputting (S414) of FIG. 4. Then the user evaluates the LSI performance using the ring oscillator ROj incorporated into the LSI at the evaluation stage subsequent to the manufacture stage. The design operation result (that is, such two-dimensional regression equation Fi) expresses the minimum ring oscillator ROj necessary to reproduce the delay value Di of the critical path CPi. Accordingly, the user can evaluate the LSI performance without excessively enlarging the circuit size of the LSI.

In the third embodiment, the two-dimensional regression equation Fi is generated in consideration of the process sensitivity in accordance with the types (NMOS and PMOS) of the transistor. According to the third embodiment, accuracy (correlation coefficient ρi) of reproducing the delay value Di of the critical path CPi can be improved compared with the first embodiment.

In the third embodiment, by way of example, the two-dimensional regression equation Fi is generated to reproduce the delay value Di of the critical path CPi. Alternatively, a two-dimensional regression equation Fi may be generated to reproduce the delay value DNi of the critical net CNi of the second embodiment.

In the third embodiment, the two-dimensional regression equation Fi is generated by way of example. Alternatively, an n-dimensional (n denotes an integer greater than 3) regression equation Fi may be generated. When the n-dimensional regression equation Fi is generated, the process table of TABLE 8 includes n process sensitivities. The n process sensitivities indicate the process sensitivities in accordance with the types of the NMOS transistor and PMOS transistor. That is, the regression equation generator 110 generates the n-dimensional regression equation Fi corresponding to the number of process sensitivities.

In the first to third embodiments, a switching structure such as a mask, an eFUSE or a resistor may be incorporated into the LSI so as to switch between a circuit that includes the ring oscillator ROj incorporated in the LSI based on such regression equation Fi, which evaluates the LSI performance, and a circuit that does not include the ring oscillator ROj, which implements the LSI performance, by a predetermined method.

At least a portion of a design apparatus 1 according to the above-described embodiments may be composed of hardware or software. When at least a portion of the design apparatus 1 is composed of software, a program for executing at least some functions of the design apparatus 1 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the design apparatus 1 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A design apparatus comprising:
an extractor configured to extract a critical part from a net list of a semiconductor integrated circuit, the critical part having a delay value greater than a delay threshold;
a regression equation generator configured to generate a regression equation to reproduce the delay value of the critical part using a regression algorithm; and
an output module configured to output the regression equation.

2. The apparatus of claim 1, further comprising:
a critical characteristic generator configured to generate a critical characteristic of the critical part using a process condition and the regression algorithm;
a determination module configured to calculate a correlation coefficient of the regression equation based on a difference between a reproduction characteristic of a delay reproduction module in the regression equation and the critical characteristic, and determine whether the calculated correlation coefficient is equal to or greater than a correlation threshold; and
an algorithm selector configured to select the regression algorithm used by the critical characteristic generator of a plurality of regression algorithms and change the regression algorithm when the determination module determines that the correlation coefficient is lower than the correlation threshold,
wherein the output module outputs the regression equation when the determination module determines that the correlation coefficient is equal to or greater than the correlation threshold.

3. The apparatus of claim 2, wherein the critical characteristic comprises a process sensitivity, a source voltage sensitivity and a temperature sensitivity, the process sensitivity indicating a degree of dependence of the delay value of the critical part on the process in manufacturing the semiconductor integrated circuit, the source voltage sensitivity indicating a degree of dependence of the delay value of the critical part on a source voltage of the semiconductor integrated circuit, the temperature sensitivity indicating a degree of dependence of the delay value of the critical part on an operation temperature of the semiconductor integrated circuit.

4. The apparatus of claim 3, wherein the process sensitivity comprises a plurality of values in accordance with a type of a transistor in the delay reproduction module, and
the regression equation generator generates a n-dimensional (n denotes an integer greater than 2) regression equation in accordance with a number of the values in the process sensitivity.

5. The apparatus of claim 1, wherein the extractor extracts at least one of a critical path and a critical net as the critical part, the critical path being between two nodes in the net list, the critical net comprising a plurality of paths comprising the critical path.

6. The apparatus of claim 2, wherein the extractor extracts at least one of a critical path and a critical net as the critical part, the critical path being between two nodes in the net list, the critical net comprising a plurality of paths comprising the critical path.

7. The apparatus of claim 3, wherein the extractor extracts at least one of a critical path and a critical net as the critical part, the critical path being between two nodes in the net list, the critical net comprising a plurality of paths comprising the critical path.

8. The apparatus of claim 4, wherein the extractor extracts at least one of a critical path and a critical net as the critical part, the critical path being between two nodes in the net list, the critical net comprising a plurality of paths comprising the critical path.

9. A method for having a computer design a semiconductor integrated circuit, the method comprising:
extracting a critical part from a net list of the semiconductor integrated circuit, the critical part having a delay value greater than a delay threshold;
generating a regression equation to reproduce the delay value of the critical part using a regression algorithm; and
outputting the regression equation.

10. The method of claim 9, further comprising:
generating a critical characteristic of the critical part using a process condition and the regression algorithm;
calculating a correlation coefficient of the regression equation based on a difference between a reproduction characteristic of a delay reproduction module in the regression equation and the critical characteristic, and determine whether the calculated correlation coefficient is equal to or greater than a correlation threshold; and
selecting the regression algorithm used to generate the critical characteristic of a plurality of regression algorithms;
changing the regression algorithm when it is determined that the correlation coefficient is lower than the correlation threshold,
wherein in outputting the regression equation, the regression equation is outputted when it is determined that the correlation coefficient is equal to or greater than the correlation threshold.

11. The method of claim 10, wherein the critical characteristic comprises a process sensitivity, a source voltage sensitivity and a temperature sensitivity, the process sensitivity indicating a degree of dependence of the delay value of the critical part on the process in manufacturing the semiconductor integrated circuit, the source voltage sensitivity indicating a degree of dependence of the delay value of the critical part on a source voltage of the semiconductor integrated circuit, the temperature sensitivity indicating a degree of dependence of the delay value of the critical part on an operation temperature of the semiconductor integrated circuit.

12. The method of claim 11, wherein the process sensitivity comprises a plurality of values in accordance with a type of a transistor in the delay reproduction module, and
in generating the regression equation, a n-dimensional (n denotes an integer greater than 2) regression equation in accordance with a number of the values in the process sensitivity is generated.

13. The method of claim 9, wherein in extracting the critical part, at least one of a critical path and a critical net as the critical part is extracted, the critical path being between two nodes in the net list, the critical net comprising a plurality of paths comprising the critical path.

14. The method of claim 10, wherein in extracting the critical part, at least one of a critical path and a critical net as the critical part is extracted, the critical path being between two nodes in the net list, the critical net comprising a plurality of paths comprising the critical path.

15. The method of claim 11, wherein in extracting the critical part, at least one of a critical path and a critical net as the critical part is extracted, the critical path being between two nodes in the net list, the critical net comprising a plurality of paths comprising the critical path.

16. The method of claim 12, wherein in extracting the critical part, at least one of a critical path and a critical net as the critical part is extracted, the critical path being between two nodes in the net list, the critical net comprising a plurality of paths comprising the critical path.

17. A non-transitory computer readable medium configured to store a program comprising instructions for:
extracting a critical part from a net list of the semiconductor integrated circuit, the critical part having a delay value greater than a delay threshold;
generating a regression equation to reproduce the delay value of the critical part using a regression algorithm; and
outputting the regression equation.

18. The medium of claim 17, further comprising:
generating a critical characteristic of the critical part using a process condition and the regression algorithm;
calculating a correlation coefficient of the regression equation based on a difference between a reproduction characteristic of a delay reproduction module in the regression equation and the critical characteristic, and determine whether the calculated correlation coefficient is equal to or greater than a correlation threshold; and
selecting the regression algorithm used to generate the critical characteristic of a plurality of regression algorithms;
changing the regression algorithm when it is determined that the correlation coefficient is lower than the correlation threshold,
wherein in outputting the regression equation, the regression equation is outputted when it is determined that the correlation coefficient is equal to or greater than the correlation threshold.

19. The medium of claim 18, wherein the critical characteristic comprises a process sensitivity, a source voltage sensitivity and a temperature sensitivity, the process sensitivity indicating a degree of dependence of the delay value of the critical part on the process in manufacturing the semiconductor integrated circuit, the source voltage sensitivity indicating a degree of dependence of the delay value of the critical part on a source voltage of the semiconductor integrated circuit, the temperature sensitivity indicating a degree of dependence of the delay value of the critical part on an operation temperature of the semiconductor integrated circuit.

20. The medium of claim 19, wherein the process sensitivity comprises a plurality of values in accordance with a type of a transistor in the delay reproduction module, and
in generating the regression equation, a n-dimensional (n denotes an integer greater than 2) regression equation in accordance with a number of the values in the process sensitivity is generated.
